(19) United States
(12) Patent Application Publication
(10) Pub. No.: US 2024/0077365 A1
(43) Pub. Date: Mar. 7, 2024

(54) Temperature Measurement Facility

(71) Applicant: Siemens Aktiengesellschaft, Muenchen (DE)

(72) Inventors: Tim SCHERER, Karlsruhe (DE); Thomas BIERWEILER, Stutensee (DE); Stefan VON DOSKY, Karlsruhe (DE)

(21) Appl. No.: 18/242,100

(22) Filed: Sep. 5, 2023

(30) Foreign Application Priority Data
Sep. 6, 2022 (EP) 22194165

(51) Int. Cl. G01K 3/14; G01K 1/02; G01K 1/143; G01K 13/02

(52) U.S. Cl. CPC G01K 3/14; G01K 1/026; G01K 1/143; G01K 13/02

(57) ABSTRACT

A temperature measurement facility for determining a medium temperature of a medium from first and second temperatures at a location immediately around a surface surrounding the medium includes a first and second sensors for determining the first and second temperatures, and a measured value processor connected to the first and second sensors by a first and second feed lines and which provides, cyclically over time, at a measurement interval the first and second temperatures as the measured value for determining the medium temperature, wherein an evaluator is configured to determine a rate of change, from a difference between the first and second temperatures, and depending on its value configured to provide a quality feature, and is further configured to transmit the quality feature, as an evaluation of a measurement accuracy of the medium temperature, together with the measured value of the medium temperature, to a higher-level system.

### BACKGROUND OF THE INVENTION

### 1. Field of the Invention

The invention relates to a temperature measurement facility for determining a medium temperature of a medium from a first temperature and a second temperature at a measurement location in the area immediately around a surface that surrounds the medium, comprising a first sensor for determining the first temperature, a second sensor for determining the second temperature, and a measured value processor which is connected to the first sensor by a first feed line and connected to the second sensor by a second feed line and which provides, cyclically over time, at a measurement interval the first temperature and the second temperature as measured values for determining the medium temperature.

### 2. Description of the Related Art

Unexamined but published application DE 198 00 753 A1 discloses a method by which a non-invasive measurement technique can be performed with a temperature measurement facility having an associated sensor. That is, DE 198 00 753 A1 already discloses a sensor for a non-invasive temperature measurement, in particular in a fluid flowing in a pipe. The temperature of the medium for measurement is determined from a heat flow behavior dQ/dt of the sensor, and external measured temperatures.

Namur Recommendation NE 107 “Self-Monitoring and Diagnosis of Field Devices” calls for self-monitoring for temperature measurement devices, and lists various types of malfunction that are to be identified.

In particular in the case of non-invasive temperature measurement, unpredictable external conditions may have an effect on the accuracy of measurement. The external conditions might be, for example:
1. incorrect assembly,
2. an abrupt fluctuation in the ambient temperature as a result of missing and/or defective insulation, and
3. jumps in the measured temperature, for example as a result of flushing with hot/cold liquid or gases.

### SUMMARY OF THE INVENTION

It is the object of the present invention to achieve intrinsic evaluation of the accuracy of measurement for a non-invasive temperature measurement device, and hence to meet the requirements of Namur Recommendation NE 107.

This and other objects and advantages are achieved in accordance with the invention by a temperature measurement facility that includes an evaluator that is configured to determine a rate of change from a difference between a first temperature and a second temperature, and depending on this value to provide a quality feature, where the evaluator is further configured to transmit the quality feature, as an evaluation of a measurement accuracy of the medium temperature, together with the measured value of the medium temperature, to a higher-level system.

The quality feature is, for example, a quality code. The invention describes the effect that a difference quotient of the difference between the first temperature and the second temperature in the steady state deviates markedly from a difference quotient in a non-steady state. This deviation or change in the difference quotient dT/dt (t1-t2), where t2 represents the second temperature and t1 the first temperature, is monitored and transmitted as a quality feature, together with the measured value. Here, the first temperature is the temperature closer to the medium, also designated the lower temperature. T2, in turn, is the temperature above it, also called the upper temperature. A quality feature or quality code of this kind may take different forms. A first form might be a simple 1-bit output of good/bad; a second form might be an n-bit output with a plurality of quality gradations based on the amplitude of the difference quotient; a further form might be that this information is communicated to a process control system, as a gradation of the accuracy, using the accuracy classes of DIN IEC 751.

In a further embodiment of the temperature measurement facility, an analyzer is provided that is configured to record the rate of change as a confidence curve that is uninterrupted over time, and to store this confidence curve in a storage device from which, when necessary, the confidence curve can be uploaded to the higher-level system via a network interface, for diagnostic purposes.

It is thus possible to display, in the higher-level systems, abrupt fluctuations in the ambient temperature and also jumps in the temperature of the medium, and a person operating the plant can accordingly respond to this and need not necessarily interpret it as a measurement error.

The uninterrupted confidence curve accordingly corresponds to a trust level, which lies in a range of +/−0.02 throughout the entire measurement series when there is a steady state. In regions where a steady state is not present, there are deviations in this difference quotient. Consequently, it is possible to derive a correlation between the confidence curve or trust level (difference quotient) and the measurement error from the confidence curve, building on the record of the uninterrupted rate of change.

For a particularly exact determination of temperature, it is advantageous if the measurement processing means is configured to calculate the temperature of the medium using the following relationship:

MT=T1+k0×(T1−T2)+k1×d(T1−T2)/dt

or expressed differently

$${T}_{p r o c e s s} = {T}_{surface} + {k}_{0} ( {T}_{surface} - {T}_{top} ) + {k}_{1} \frac{d}{dt} ( {T}_{surface} - {T}_{top} )$$

and hence to improve the accuracy in dynamic behavior.

In the simplest case, the temperature of the medium, and thus the temperature, such as in a process pipe, are determined using MT=T1+KO×(T1−T2). A first correction factor is determined metrologically, for example, in a laboratory, for wall materials of different thermal conductivities and at least two wall thicknesses. It is then possible for linear interpolation for process pipes of other wall thicknesses to occur.

In a further form, it is then possible, in addition to a linear term of the equation, to utilize the difference quotient, i.e., the change rate. This enables the response time to be further improved. The temperature in the process pipe is then determined using the relationship: MT=T1+k0×(T1−T2)+k1×d(T1−T2)/dT. In addition, a further correction factor or offset can be added.

With respect to a simplified diagnostic for the measured value in a higher-level processing system, it is advantageous if the temperature measurement facility has a classifier that is configured to allocate an accuracy class to each measured value, depending on the value of the change rate.

With respect to the accuracy classes and the classification, it is possible, for example, to proceed in conformance with the appropriate standard. With the aid of the self-diagnostic function that is thus introduced, the plausibility of the measured values and of proper functioning of the sensor system and temperature measurement facility is validated. This is done through continuous monitoring of the signal quality. As a result, negative influences on the measured values or on the sensor system are identified, and these may be communicated by status message to the operating personnel, who, with these status messages, is once again better able to interpret the measured values. Persons operating plant of this kind benefit from enhanced availability of the plant, and can, for example, undertake maintenance precisely when this is needed.

Furthermore, the temperature measurement facility is equipped with a thermal coupling element, which serves as a measuring head and in which the sensors are arranged, where the thermal coupling element has a coupling face and is configured for mounting on a container or pipe, with the coupling face facing the surface of the container or the surface of the pipe.

The accuracy of measurement is further enhanced if the first sensor and the second sensor are arranged in the thermal coupling element at different distances from the coupling face.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the invention, in which:

FIG. 1 shows a sensor unit comprising a first and a second temperature sensor in accordance with the invention;

FIG. 2 shows a schematic block diagram of the temperature measurement facility in accordance with the invention;

FIG. 3 shows a graphical plot of a measurement curve for a temperature measurement in accordance with the invention;

FIG. 4 shows a graphical plot of a measurement series with an associated graphical plot of a confidence curve in accordance with the invention;

FIG. 5 shows an exemplary determination of a correction factor experimentally; and

FIG. 6 shows a further exemplary determination of the correction factor experimentally.

### DETAILED DESCRIPTION OF THE EXEMPLARY EMBODIMENTS

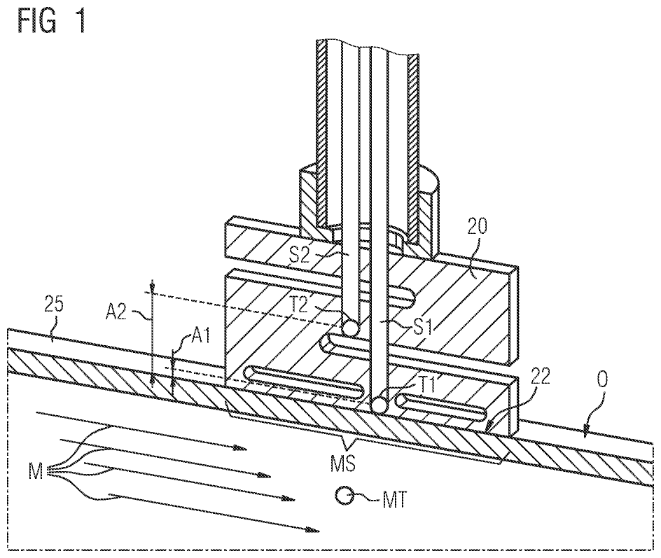

FIG. 1 illustrates a thermal coupling element 20 of the temperature measurement facility 100. The thermal coupling element 20 is configured as a measuring head 21 in which a first sensor S1 and a second sensor S2 are arranged. The thermal coupling element 20 has a coupling face 22, and is configured for mounting on a pipe 25. The coupling face 22 faces the surface O of the pipe 25.

A medium M flows in the pipe 25, with the temperature measurement facility 100 being configured to determine a medium temperature MT of the medium M from a first temperature T1 and a second temperature T2 at a measurement location MS in the area immediately around a surface O that surrounds the medium M. The first sensor S1 and the second sensor S2 in the thermal coupling element 20 are arranged at different distances A1, A2 from the coupling face 22. Thus, the first sensor S1 is arranged at a first distance A1 and the second sensor S2 is arranged at a second distance A2 from the coupling face 22.

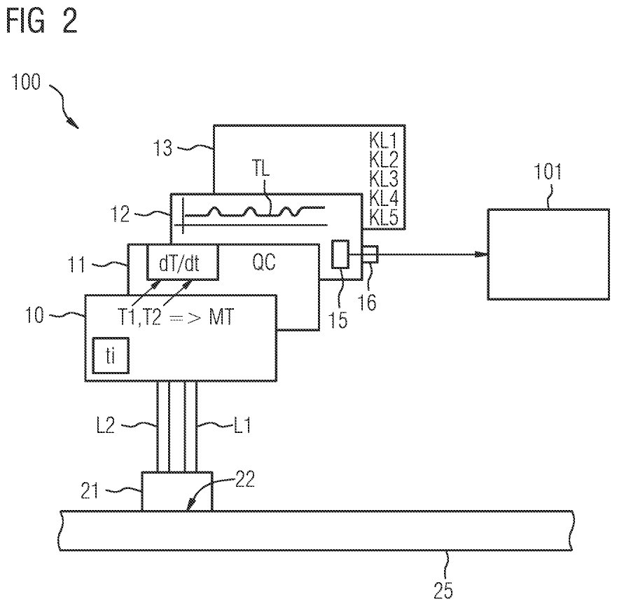

FIG. 2 shows the temperature measurement facility 100 for determining the medium temperature MT of the medium M in FIG. 1. The temperature values can be fed to a measured value processor 10 via the first sensor S1 for determining the first temperature T1 and the second sensor S2 for determining the second temperature T2. The measured values are passed to the measured value processor 10 over a first line L1 and a second line L2. The measured value processor 10 is configured to provide, cyclically over time t, at a measurement interval t1 the first temperature T1 and the second temperature T2 as the measured value for determining the medium temperature MT. In order to provide a quality feature QC as an evaluation of a measurement accuracy of the medium temperature MT, the temperature measurement facility 100 has an evaluator 11. The evaluator 11 is configured to determine a change rate dT/dt from a difference between the first temperature T1 and the second temperature T2, and depending on its value to provide the quality feature QC. Furthermore, the evaluator 11 is configured to transmit the quality feature QC, as an evaluation of the accuracy of measurement of the medium temperature MT, together with the measured value of the medium temperature MT, to a higher-level system 101.

Furthermore, the temperature measurement facility 100 has an analyzer 12, which is configured to record the change rate dT/dt as a confidence curve TL that is uninterrupted over time, and to store it in a storage device 15. The analyzer 12 is furthermore configured such that the higher-level system 101 can upload the confidence curve TL when necessary via a network interface 16, for diagnostic purposes.

Advantageously, the following relationship is implemented in the measured value processor 10:

MT=T1+k0×(T1−T2)+k1×d(T1−T2)/dt

Furthermore, the temperature measurement facility 100 has a classifier 13 that is configured to allocate an accuracy class KL1, . . . ,KL5 to each measured value, depending on the value of the change rate dT/dt. Accordingly, there may be added a measured value as a quality feature QC a first accuracy class KL1, a second accuracy class KL2, a third accuracy class KL3, a fourth accuracy class KL4 or a fifth accuracy class KL5.

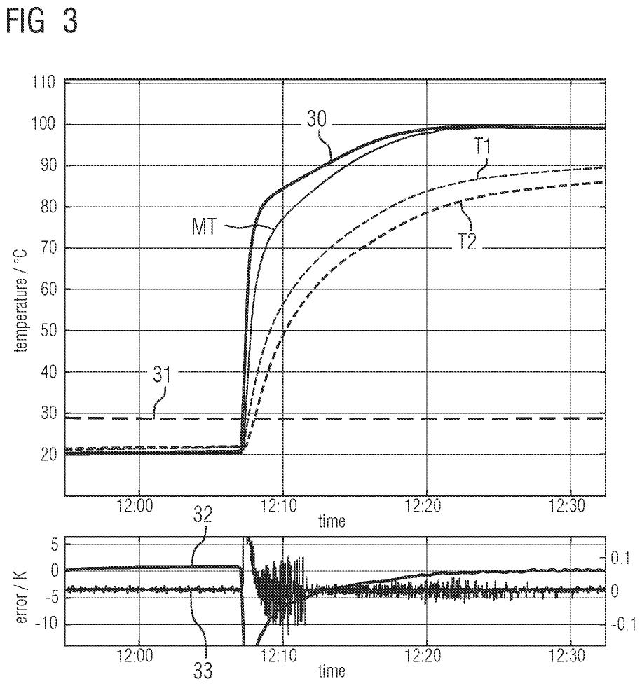

In an upper graphical plot, FIG. 3 shows a reference temperature 30, an ambient temperature 31, a medium temperature MT, a first temperature T1, and a second temperature T2. The temperature curve of the medium temperature MT is determined from the temperature curves T1, T2, using the above-mentioned relationship.

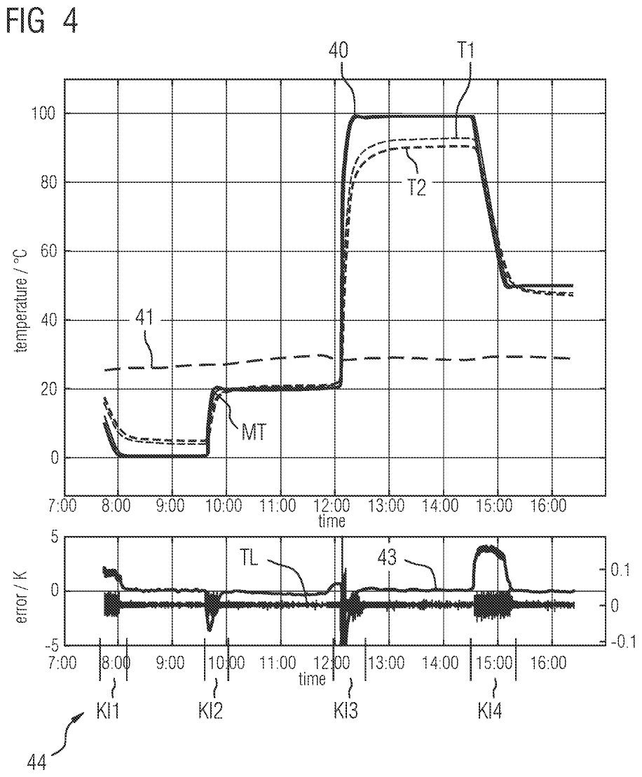

Furthermore, FIG. 3 shows the associated curve of a rate of change 33 with an error value 32 (in kelvin). FIG. 3 illustrates a measured value curve for a jump in temperature from 20 to 100 degrees. Because the rate of change dT/dt alters rapidly with the jump in temperature, this can be obtained from the error 32 and the change rate 33, which in FIG. 4 is illustrated as a confidence curve TL.

FIG. 4 shows a complete measurement curve with a reference temperature 40, an ambient temperature 41, an error value 43 and the confidence curve TL (trust level). Once again, the medium temperature MT is determined using the relationship from the first temperature T1 and the second temperature T2.

The confidence curve TL may be divided into correction intervals KI1, . . . ,KI4. Thus, for example, a first correction interval KI1 is indicated in a measured time period from about 7:40 to 8:10, a second correction interval KI2 is indicated in a time range from 9:40 to 9:45, a third correction interval KI3 is indicated in a time range from 12:00 to 12:45, and a fourth correction interval KI4 is indicated in a time range from 14:30 to 15:20.

These correction intervals KI1, . . . KI4 can now be evaluated by software, or even presented to a person operating the plant as a signal curve. This means that, whenever a correction interval KI1, . . . ,KI4 of this kind is evaluated or displayed to a person operating the plant, the person knows that measurement of the measured value that is to be determined, i.e., the medium temperature MT, does not necessarily have to be error-free, because it possible to assume there is a high change rate dT/dt. In addition, it is possible for quality features QC in the form of accuracy classes KL1, . . . ,KL5, which are also determined from the line taken by the confidence curve TL in the correction intervals KI1, . . . ,KI4 and passed on, to be for the determined measured value for the medium temperature MT.

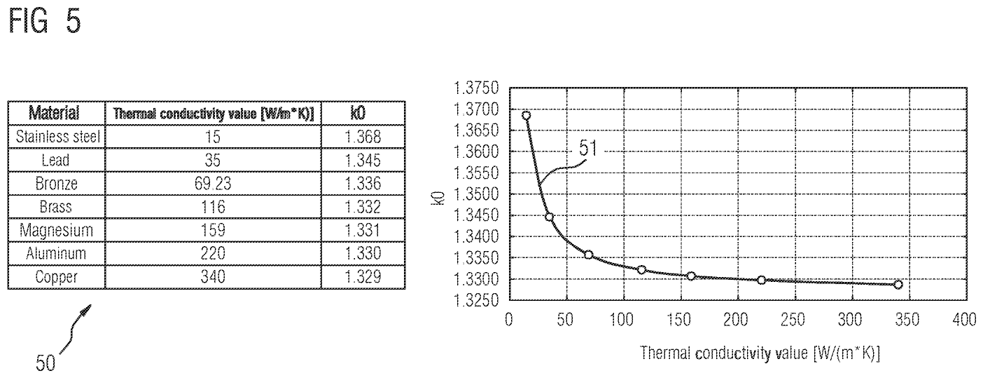

FIG. 5 shows a table of materials 50 and a correction factor curve 51. The correction factors K0, K1 that are utilized in the relationship for determining the medium temperature MT are determined by experiment in laboratory tests. Thus, the temperature is determined by measurement with different materials, such as stainless steel, lead, bronze, brass, magnesium, aluminum and copper and their associated thermal conductivity values, and the correction factor is determined from the thermal conductivity value using the value calculated from the formula.

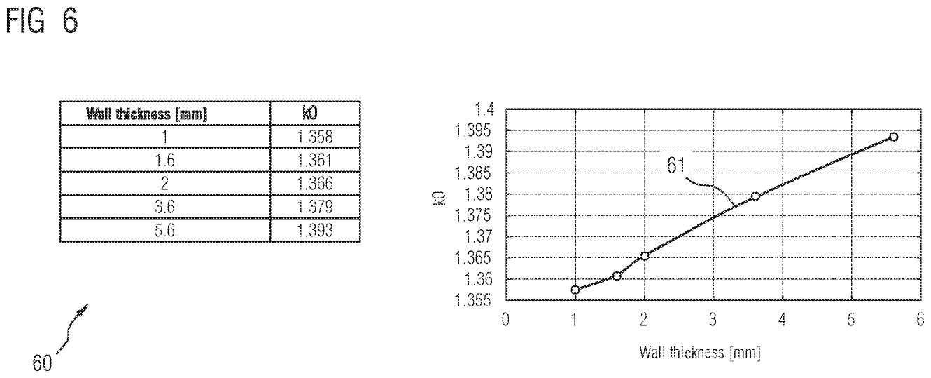

In FIG. 6, the correction factor is determined with the aid of different wall thicknesses, which are presented in a table of wall thicknesses 60. Thus, for example, using the measured value of the medium M from actual measurements and the calculated measured value from the formula, it is possible to determine metrologically a correction factor curve 61 for different wall thicknesses, such as 1, 1.6, 2, 3.6 and 5.6 mm.

The determined correction factors that were determined by experiment in the laboratory are integrated into the formula in order to improve measurement accuracy and the determining of measured values.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A temperature measurement facility for determining a medium temperature of a medium from a first temperature and a second temperature at a measurement location in an area immediately around a surface which surrounds the medium, the temperature measurement facility comprising:
a first sensor for determining the first temperature;
a second sensor for determining the second temperature; and
a measured value processor connected to the first sensor by a first feed line and connected to the second sensor by a second feed line and which provides, cyclically over time, at a measurement interval the first temperature and the second temperature as the measured value for determining the medium temperature;
an evaluator which is configured to determine a rate of change from a difference between the first temperature and the second temperature and configured, depending on a value of the determined rate of change to provide a quality feature, and further configured to transmit the quality feature, as an evaluation of a measurement accuracy of the medium temperature, together with the measured value of the medium temperature, to a higher-level system.

2. The temperature measurement facility as claimed in claim 1, further comprising:
an analyzer which is configured to record the rate of change as a confidence curve which is uninterrupted over time, and to store the recorded confidence curve in a storage device from which, when necessary, the confidence curve is uploaded to the higher-level system via a network interface for diagnostic purposes.

3. The temperature measurement facility as claimed in claim 1, wherein the measurement processor is further configured to calculate the temperature of the medium utilizing the relationship:
MT=T1+k0×(T1−T2)+k1×d(T1−T2)/dt
and hence to improve dynamic behavior accuracy.

4. The temperature measurement facility as claimed in claim 2, wherein the measurement processor is further configured to calculate the temperature of the medium utilizing the relationship:
MT=T1+k0×(T1−T2)+k1×d(T1−T2)/dt
and hence to improve dynamic behavior accuracy.

5. The temperature measurement facility as claimed in claim 1, further comprising:
a classifier which is configured to allocate an accuracy class to each measured value, depending on the value of the change rate.

6. The temperature measurement facility as claimed in claim 2, further comprising:
a classifier which is configured to allocate an accuracy class to each measured value, depending on the value of the change rate.

7. The temperature measurement facility as claimed in claim 3, further comprising:
a classifier which is configured to allocate an accuracy class to each measured value, depending on the value of the change rate.

8. The temperature measurement facility as claimed in claim 1, further comprising:
a thermal coupling element which serves as a measuring head, the first and second sensors being arranged thermal coupling element;
wherein the thermal coupling element includes a coupling face and is configured for mounting on a container or pipe, the coupling face facing the surface of the container or the surface of the pipe.

9. The temperature measurement facility as claimed in claim 2, further comprising:
a thermal coupling element which serves as a measuring head, the first and second sensors being arranged thermal coupling element;
wherein the thermal coupling element includes a coupling face and is configured for mounting on a container or pipe, the coupling face facing the surface of the container or the surface of the pipe.

10. The temperature measurement facility as claimed in claim 3, further comprising:
a thermal coupling element which serves as a measuring head, the first and second sensors being arranged thermal coupling element;
wherein the thermal coupling element includes a coupling face and is configured for mounting on a container or pipe, the coupling face facing the surface of the container or the surface of the pipe.

11. The temperature measurement facility as claimed in claim 5, further comprising:
a thermal coupling element which serves as a measuring head, the first and second sensors being arranged thermal coupling element;
wherein the thermal coupling element includes a coupling face and is configured for mounting on a container or pipe, the coupling face facing the surface of the container or the surface of the pipe.

12. The temperature measurement facility as claimed in claim 4, wherein the first and second sensors are arranged in the thermal coupling element at different distances from the coupling face.
